(19) United States
(12) Patent Application Publication
(10) Pub. No.: US 2015/0100481 A1
(43) Pub. Date: Apr. 9, 2015

(54) APPARATUS, METHOD, AND COMPUTER PROGRAM PRODUCT FOR TENDER TYPE SCALING USING AN ON-LINE BILL PAYMENT PLATFORM

(71) Applicant: Mastercard International Incorporated, Purchase, NY (US)

(72) Inventors: Debashis Ghosh, Charlotte, NC (US); Randy Shuken, Westport, CT (US)

(73) Assignee: Mastercard International Incorporated, Purchase, NY (US)

(21) Appl. No.: 14/048,958

(22) Filed: Oct. 8, 2013

(51) Int. Cl. G06Q 20/10; G06Q 20/34

(52) U.S. Cl. CPC G06Q 20/102; G06Q 20/34
USPC 705/40

(57) ABSTRACT

Access is obtained to a database of transactions in an electronic bill payment system connecting a plurality of customers with a plurality of billers. At least some of the billers are payment card issuers. A subset of records in the database, associated with a subset of the customers in a region of interest, is identified. In the subset of records, transactions that are payments to the billers that are payment card issuers are identified. Within the transactions that are payments to the billers that are payment card issuers, a proportional amount attributable to each of a plurality of brands of payment card products is determined. The proportional amount is made available for computation.

### FIELD OF THE INVENTION

The present invention relates generally to the electronic and computer arts, and, more particularly, to analysis of electronic payment techniques.

### BACKGROUND OF THE INVENTION

The use of payment cards, such as credit cards, debit cards, and pre-paid cards, has become ubiquitous. Most payment card accounts have one or more associated physical cards; however, the use of non-traditional payment devices, such as appropriately configured “smart” cellular telephones, is increasing. A wealth of transaction data is available, based on the use of payment card accounts.

The process of electronic bill presentment and payment has also been popular for quite some time. For example, U.S. Pat. No. 5,699,528 to Hogan (expressly incorporated herein by reference in its entirety for all purposes) discloses a system and method for bill delivery and payment over a communications network. In the bill delivery and payment system, users are able to access a server computer on a communications network to obtain bill information and pay bills.

### SUMMARY OF THE INVENTION

Principles of the present invention provide techniques for tender type scaling using an on-line bill payment platform. At least some aspects of the techniques may be facilitated by the operator of a payment network or other service provider.

In one aspect, an exemplary method includes the step of obtaining access to a database of transactions in an electronic bill payment system connecting a plurality of customers with a plurality of billers. At least some of the billers are payment card issuers. Further steps include identifying a subset of records in the database that are associated with a subset of the customers in a region of interest; and identifying, in the subset of records, transactions that are payments to the billers who are payment card issuers. Even further steps include, within the transactions that are payments to the billers who are payment card issuers, determining a proportional amount attributable to each of a plurality of brands of payment card products; and making the proportional amount available for computation.

Aspects of the invention contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the invention can provide substantial beneficial technical effects, including, for example, an automated way of determining scaling factors as compared to the current ad hoc nature of computing scaling factors.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the invention;

FIG. 3 shows exemplary operation of a bill pay system, in accordance with an aspect of the invention;

FIG. 4 shows exemplary operation of current automated clearinghouse payments;

FIG. 5 is a block diagram of an exemplary computer system useful in one or more embodiments of the invention;

FIG. 6 shows an exemplary spreadsheet used in tender type scaling, in accordance with an aspect of the invention;

FIG. 7 is a flow chart of an exemplary method, in accordance with an aspect of the invention;

FIG. 8 shows exemplary geographical regions of interest, in accordance with an aspect of the invention; and

FIG. 9 is a flow chart of one non-limiting exemplary method for carrying out step 710 of FIG. 7, in accordance with an aspect of the invention.

### DETAILED DESCRIPTION OF PREFERRED EMBODIMENTS

At least some embodiments employ data from electronic bill payment systems (optionally, with presentment functionality) to carry out tender type scaling for payments made with payment cards or other portable payment devices.

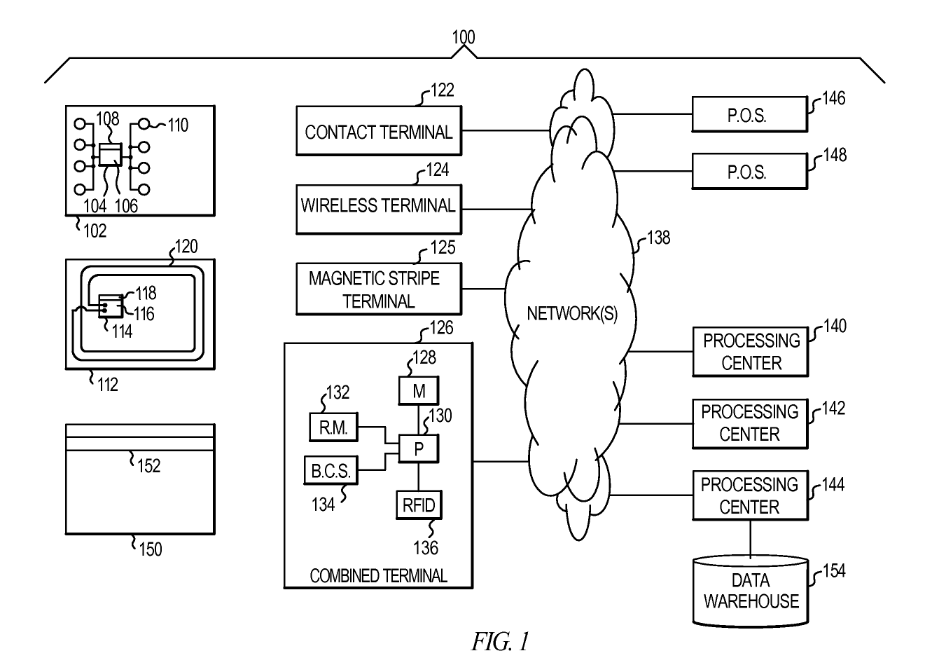

With regard to payment card and similar payments, attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present invention is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, NY, USA (marks of MasterCard International Incorporated of Purchase, NY, USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

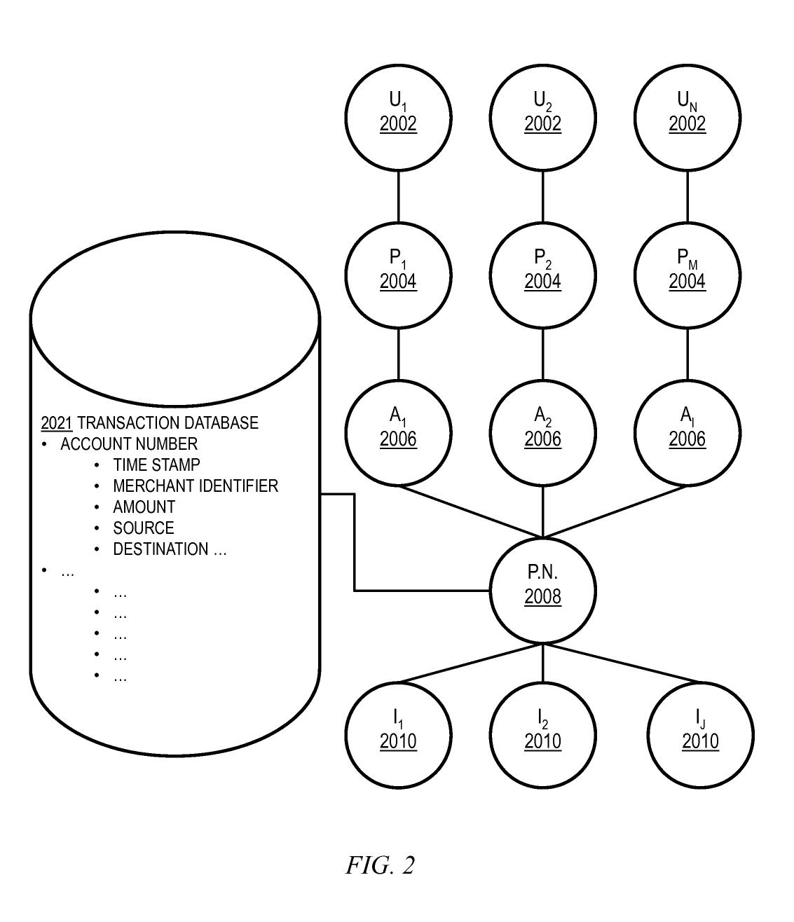

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions. Tender type scaling for such accounts can also be carried out in one or more embodiments.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

Transaction database 2021 is discussed below.

It will be appreciated that the network 2008 shown in FIG. 2 is an example of a payment network configured to facilitate transactions between multiple issuers and multiple acquirers, which may be thought of as an “open” system. Some embodiments of the invention may be employed to carry out tender type scaling in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, New York, USA); by way of example and not limitation, techniques of U.S. Pat. Nos. 6,636,833 and 7,136,835 of Flitcroft et al., the complete disclosures of both of which are expressly incorporated herein by reference in their entireties for all purposes.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

As noted, at least some embodiments employ data from electronic bill payment systems (optionally, with presentment functionality) to carry out tender type scaling for payments made with payment cards or other portable payment devices. Electronic bill payment systems are conceptually different than payment card networks, and will often use electronic funds transfer from a demand deposit account. In some instances, a single entity, such as MasterCard International Incorporated (a non-limiting example) will operate both a payment card network and an electronic bill payment system (optionally, with presentment functionality).

With regard to electronic bill presentment and payment systems, inventive techniques can be employed in a number of different environments. In one or more embodiments, inventive techniques can be employed in connection with the MASTERCARD RPPS® electronic payment system of MasterCard International Incorporated of Purchase, New York, USA. This example is non-limiting; for example, other types of electronic bill presentment and/or payment systems could be employed in other instances. Non-limiting examples are is described in:
US Patent Publication 2011-0251952 A1 of Mary L. Kelly et al.
US Patent Publication 2012-0197788 A1 of Hemal Sanghvi et al.

The above-listed Kelly and Sanghvi publications are hereby expressly incorporated by reference herein in their entireties for all purposes.

For the avoidance of doubt, references to MasterCard, unless expressly stated to be limited to MasterCard, are intended to be exemplary of an operator of an electronic bill payment system (optionally, with presentment functionality) and/or an operator of a payment network, as will be appreciated from the context, whether or not qualified by words such as “or other operator.”

Furthermore, another non-limiting example of electronic bill presentment and/or payment systems with which one or more embodiments of the invention can be employed is the CHECKFREE platform available from Fiserv, Inc. of Brookfield, Wis., USA.

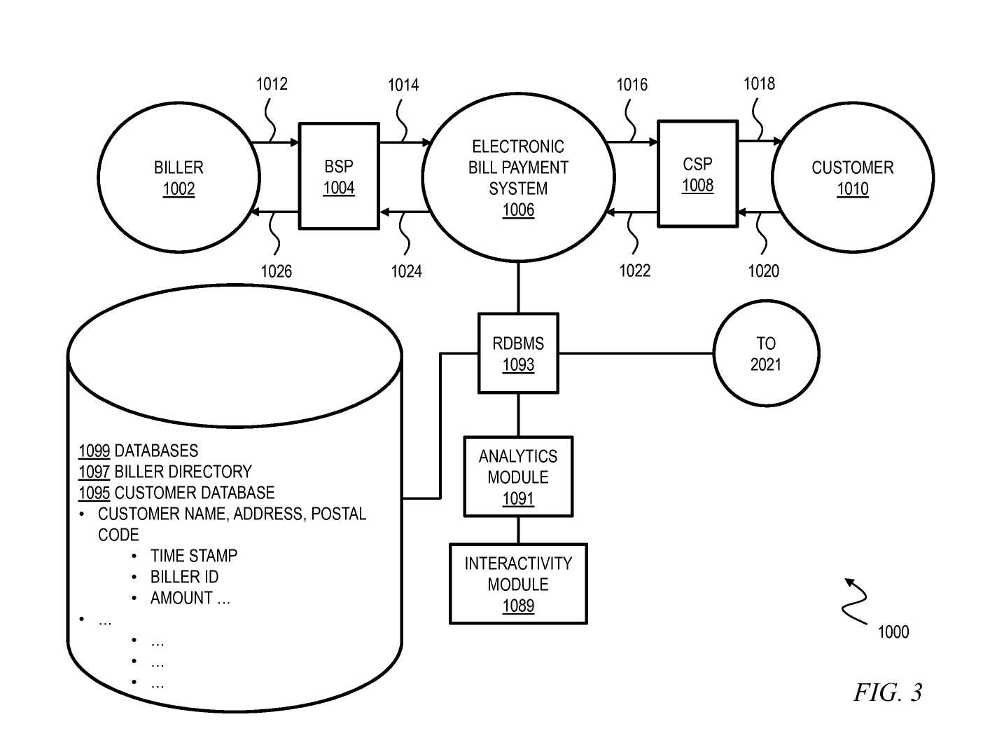

FIG. 3 shows operation of an electronic bill payment system, such as the MASTERCARD RPPS® electronic payment system, which is but one non-limiting example of such a system, modified in accordance with aspects of the invention. Given the teachings herein, the skilled artisan will be able to implement one or more embodiments of the invention using a variety of techniques; by way of example and not limitation, the modification or supplementing of an existing MASTERCARD RPPS® system or other electronic payment system as shown in FIG. 3. As shown in FIG. 3, in an approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

Database(s) 1099 including biller directory 1097 and customer database 1095 are described further below.

Note that “BPPS” is used herein as shorthand for an electronic “bill presentment and payment system”; the RPPS system is a non-limiting example of such a system.

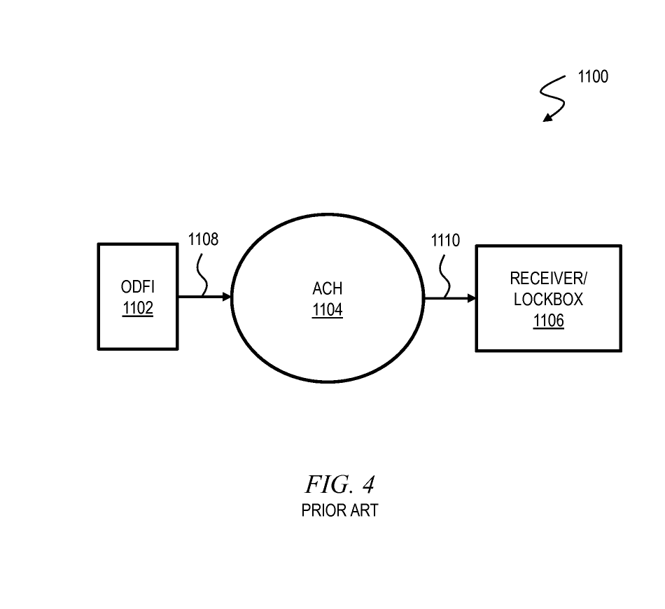

FIG. 4 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; one non-limiting example of an ACH file format is the NACHA ACH CCD file format. Other formats can also be used; for example, extensible markup language (XML). It should be noted that a variety of networks can be used, both public (for example, ACH) and proprietary (for example, the aforementioned MASTERCARD RPPS system).

One or more embodiments utilize data from an electronic bill presentment and payments system, such as system 1000, for purposes of tender type scaling. Such a system can be used for many different kinds of payments; for example, payments to a utility company, a cable television provider, and so on. Many people use a system such as system 1000 to pay credit card issuers. For example, a consumer pays the issuer of his or her MasterCard® card or VISA® card using an online bill payment with a transfer from a demand deposit account (MasterCard® and VISA® are registered marks of, respectively, MasterCard International Incorporated, Purchase, New York, USA, and Visa International Service Association, Foster City, Calif., USA).

In one or more embodiments, data from the payment card systems, such as those of FIGS. 1 and 2 may show, for example, $300 of MasterCard receipts at a particular merchant, say, ABC Dry Cleaners. For example, transaction database 2021 may include a plurality of records for a plurality of different account numbers (PANs) for a single brand of payment card products, MASTERCARD cards being a non-limiting example. Each record may include a plurality of different transactions; the record for each transaction may include, for example, a time stamp, a merchant identifier, and the amount. The ellipses indicate that each PAN has many transactions, and that there are many PANs. The total amount of MasterCard spending at a given merchant during a given time period can be determined by running a query on database 2021 to identify all the records for that merchant identifier with a time stamp during the time period of interest, and then the amount for each of these records can be summed up. Similar queries could be conducted, if desired, for all the merchants in a mall, all the merchants in a particular zip code or other area, and so on. Transactions can be, for example, in-person transactions at brick and mortar locations, or on-line (Internet) transactions.

Meanwhile, from online bill pay system 1000, it can be determined that in the zip code where the dry cleaner is operating, MasterCard has a 35% market share for payment card payments, as will be discussed further below. Then, in accordance with one or more embodiments, it can be inferred that total receipts at ABC Dry Cleaners are $300/0.35=$857. Some embodiments take into account the percentage of market share for payment card payments versus cash and check. For example, MasterCard has a 35% market share for payment card payments, and payment cards have a 75% share of the total payments market (cash and check have 25%). Then, in accordance with one or more embodiments, it can be inferred that total payment card receipts at ABC Dry Cleaners are $300/0.35=$857, and that total receipts at ABC Dry Cleaners are $857/0.75=$1143.

Some embodiments are useful in connection with consulting or advisory services wherein a consultant or advisor: (i) advises a merchant by helping to identify for the merchant the source of the merchant's customers and/or (ii) provides competitive benchmarking.

As compared to previous techniques, one or more embodiments are simpler, quicker to scale, and yield fewer errors. One or more embodiments permit the calculation of a particular brand's share of the payment card market, by scaling data from system 1000. The operator of system 1000 can determine, for a particular region (a particular zip code or other postal code is a non-limiting example), what the market share is of the different major brands of payment cards, by looking at the on-line bill payments people make to issuers of their cards. One or more embodiments allow prediction of total sales for a given merchant, category, or entire industry. In one or more embodiments, the more accurately the share of a particular brand of interest is known, the better total sales can be predicted.

Thus, a two-stage approach is used in one or more embodiments. In a first stage, data from system 1000 allows determining what share of the payment card market a particular card brand (say, MasterCard) has in a certain zip code or other area. In a second stage, with actual access to a certain merchant in that zip code or other area, and thus knowing how much money is spent at that merchant with the particular card brand (say, MasterCard branded payment products), take the percentage from the first stage, expressed as a decimal, and divide it into the total money spent at that merchant with the particular card brand to estimate the total spend with all payment card brands.

In one or more embodiments, to develop the weighting factor, proceed as follows. In system 1000, receive an order 1020, 1022 to pay, including an identification of the biller 1002 and the amount. It is worth noting that system 1000 typically includes one or more database(s) 1099, optionally including a database 1097 known as a biller directory or the like. Biller directory data is useful, for example, where payments are made to an entity such as “Card Member Services”; the Biller Directory can be consulted to determine who the corresponding payee is (name of issuer and optionally corresponding brand of payment card products; in at least some instances, the corresponding brand of payment card products is instead determined by checking the leading digit(s) of the card account number (e.g., PAN or bank card number) in a manner that is, in and of itself, known to the skilled artisan). In still another alternative, the name of the issuer and/or the corresponding brand of payment card products can be determined from the memo field(s) of the on-line payment(s). In yet a further alternative, the name of the issuer and/or the corresponding brand of payment card products can be determined directly from the payee information.

Now, continuing with the development of the weighting factor, where it is desired to determine the weighting factor for a specific zip code, using data in the biller directory or other techniques as described immediately above, determine which payments made from that specific zip code are to payment card issuers—for example, Bank of America VISA, JP Morgan Chase MasterCard. Add up the total amount of payments from that specific zip code that are to payment card issuers (typically, for some given time period—say one month or the like). Billers that are not payment card issuers are not of interest in one or more embodiments. Then, determine, out of that total amount of payments, the percentages for each brand of payment card; for example, to obtain the percentage for MasterCard cards, add up all the payments to MasterCard card issuers and divide by the total amount of payments. Furthermore in this regard, each customer 1010 may have records in customer database 1095. These records may show the customer's name, address, and ZIP or other postal code. Many transactions, including, for each transaction, a time stamp, biller ID, and amount, will be associated with each customer. The ellipses indicate that each customer has many transactions, and that there are many customers. For example, it is desired to analyze ZIP code 11227. From biller directory 1097, determine the Biller IDs of all the billers 1002 that are payment card issuers. Then, query database 1095 to return all transactions for customers living in zip code 11227 that are payments to the biller IDs for payment card issuers identified from biller directory 1097. The records for these transactions are used to carry out the weighting factor determination process just described.

In some embodiments, instead of first determining which payments are to specific issuers, and then adding all the payments to issuers of a particular brand, filter on payment card account number or the like to directly determine that a payment is for a specific brand of payment card.

Some embodiments allow for filtering payments based on source and destination.

Some embodiments further determine whether a payment is payment in full, or just the minimum payment, or some intermediate amount.

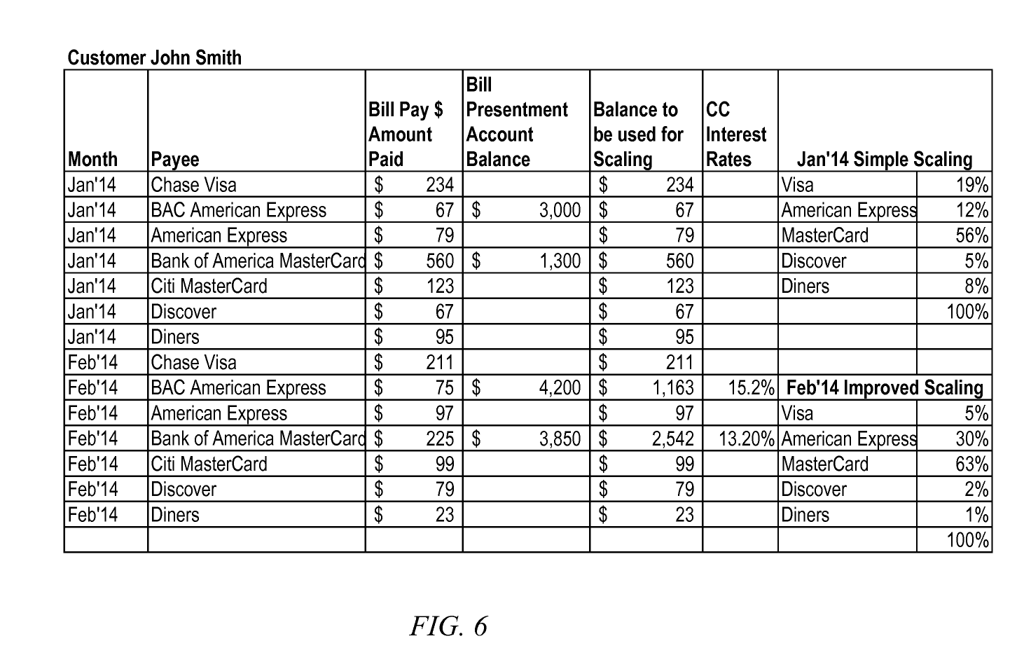

Refer now to FIG. 6, which shows an exemplary spreadsheet for scaling for a fictitious customer “John Smith.” This individual has seven different payment card products for which he makes payment to the issuer each month using an electronic bill presentment and payment system. In this non-limiting example, these seven products include:
Chase® Visa® (registered marks of JPMORGAN CHASE & CO. NEW YORK, NY, US and VISA INTERNATIONAL SERVICE ASSOCIATION, FOSTER CITY, CA, US)
Bank of America MasterCard® (registered mark of MASTERCARD INTERNATIONAL INCORPORATED, PURCHASE, NY, US)
Citi® MasterCard® (registered marks of CITIGROUP INC. NEW YORK, NY, US and MASTERCARD INTERNATIONAL INCORPORATED, PURCHASE, NY, US)
BAC American Express® (registered mark of American Express Company, its subsidiaries and/or affiliates, New York, N.Y., US)
American Express® (registered mark of AMERICAN EXPRESS COMPANY, its subsidiaries and/or affiliates, New York, N.Y., US)
Discover® (registered mark of DISCOVER FINANCIAL SERVICES CORPORATION, RIVERWOODS IL, US)
Diners Club® (registered mark of DINERS CLUB INTERNATIONAL LTD., RIVERWOODS IL, US)

Purely for illustrative purposes, in January 2014, he pays Chase Visa $234, BAC American Express $67, American Express $79, Bank of America MasterCard $560, Citi MasterCard $123, Discover $67, and Diners Club $95. Bank of America MasterCard and BAC American Express have outstanding balances greater than the amount paid ($1300 and $3000, respectively), but this is not taken into account for the simple scaling approach used in the January 2014 example. The actual amounts paid are used as the balances for scaling, namely, Chase Visa $234, BAC American Express $67, American Express $79, Bank of America MasterCard $560, Citi MasterCard $123, Discover $67, and Diners Club $95. Thus, the total for Visa products is $234, the total for American Express products is $67+$79=$146, the total for MasterCard products $560+$123=$684, the total for Discover is $67 and the total for Diners Club is $95. The grand total is $1226 and the percentages are:

Visa 234/1226*100=19%

American Express 146/1226*100=12%

MasterCard 684/1226*100=56%

Discover 67/1226*100=5%

Diners Club 95/1226*100=8%.

Purely for illustrative purposes, in February 2014, fictitious customer John Smith pays Chase Visa $211, BAC American Express $75, American Express $97, Bank of America MasterCard $225, Citi MasterCard $99, Discover $79, and Diners Club $23. Again, Bank of America MasterCard and BAC American Express have outstanding balances greater than the amount paid ($3850 and $4200, respectively); this is taken into account for the improved scaling approach used in the February 2014 example, wherein presentment data is available. The actual amounts paid are used as the balances for scaling for those products without outstanding balances greater than the amount paid, namely, Chase Visa $211, American Express $97, Citi MasterCard $99, Discover $79, and Diners Club $23. For BAC American Express, to calculate the new spending in February 2014, take the current bill presentment account balance of $4200, and subtract the previous balance of $3000 and the interest of 15.2% per annum=1.2667% per month on the portion of the previous balance not paid off:

4200−3000−(3000−67)*1.2667%=1163

Similarly, for Bank of America MasterCard, to calculate the new spending in February 2014, take the current bill presentment account balance of $3850, and subtract the previous balance of $1300 and the interest of 13.2% per annum=1.1% per month on the portion of the previous balance not paid off:

3850−1300−(1300−560)*1.1%=2542

Thus, the total for Visa products is $211, the total for American Express products is $1163+$97=$1260, the total for MasterCard products is $2542+$99=$2641, the total for Discover is $79 and the total for Diners Club is $23. The grand total is $4214 and the percentages are:

Visa 211/4214*100=5%

American Express 1260/4214*100=30%

MasterCard 2641/4214*100=63%

Discover 79/4214*100=2%

Diners Club 23/4214*100=1%.

Because of rounding, the total is 101% rather than 100%.

It will be appreciated that each payee shown FIG. 6 corresponds to a PAN for a payment card account for that issuer; for example, John Smith's PAN for his Chase Visa card is 4085 XXXX XXXX 1234; for his Bank of America MasterCard is 5491 ZZZZ ZZZZ 8765; and so on. The calculations shown in FIG. 6 are aggregated for all of the customers of system 1000 who live in the region of interest and make payments to payment card issuers.

Thus, in one or more embodiments, the operator of a payment card processing network, or some other entity to whom the data has been made available, sums up all the transactions for a given merchant for a given brand of card associated with that operator, and divides same by the decimal determined in the first phase mentioned above. In some embodiments, method steps are advantageously carried out by an entity such as MasterCard International Incorporated, which operates the BANKNET network (refer to FIGS. 1 and 2) for transaction of debit, credit, and stored value card accounts, and the RPPS® bill presentment and payment system (refer to FIG. 3). As noted above, RPPS is a non-limiting example. Furthermore, in general, method steps can be carried out, for example, by an entity which operates a bill payment (optionally with presentment) system; this entity may or may not also operate a payment card network.

Advantageously, one or more embodiments improve upon a current scenario by leveraging an online bill pay platform, such as that shown in FIG. 3, and by studying the data in aggregate, allowing quick and accurate development of tender scaling factors by geography. So, as an example, if MasterCard has a 30% market share (computed from an online bill pay platform, such as that shown in FIG. 3) and total receipts are $100, it can be estimated that the total receipts for the given merchant are $333.

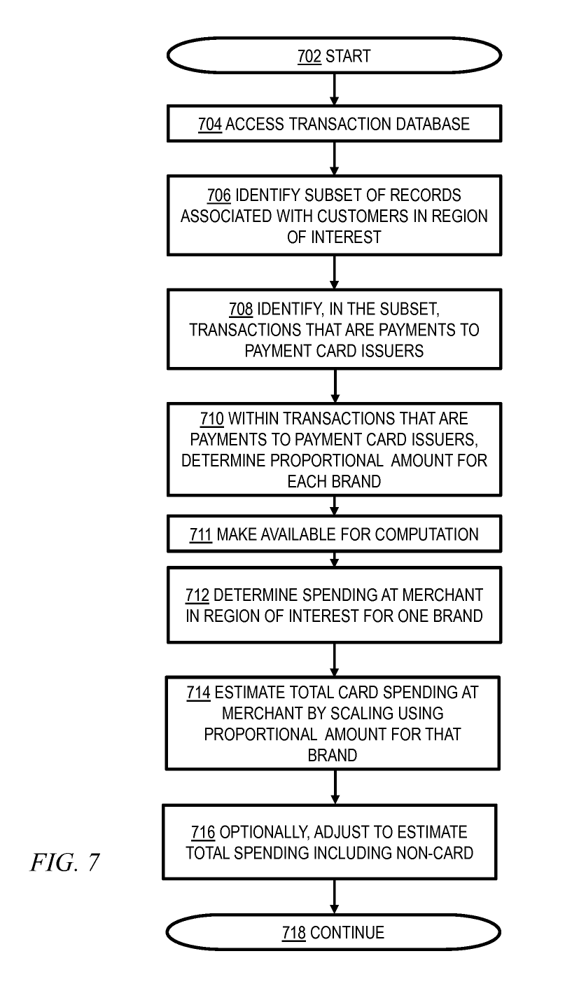

Reference should be had to the flow chart of FIG. 7, which begins at 702. Given the discussion thus far, it will be appreciated that, in general terms, an exemplary method, in accordance with an aspect of the invention, includes the step 704 of obtaining access to a database 1099 of transactions in an electronic bill payment system (e.g., 1006; may or may not have presentment capability) connecting a plurality of customers 1010 with a plurality of billers 1002. At least some of the billers are payment card issuers; issuers 2010 are non-limiting examples of payment card issuers. The electronic bill payment system may directly or indirectly (e.g., via BSP 1004 and/or CSP 1008 respectively) connect the plurality of customers 1010 with the plurality of billers. This step can be carried out, for example, with a relational database management system.

A further step 706 includes identifying a subset of records in the database 1099 that are associated with a subset of the customers in a region of interest (for example, a geographical region associated with a zip code or other postal code). This step can be carried out, for example, with a relational database management system; for example, by running a query on zip code or the like.

A still further step 708 includes identifying, in the subset of records, those transactions that are payments to those of the billers 1002 that are payment card issuers such as 2010. This step can be carried out, for example, with a relational database management system; for example, by running a query on Biller ID or the like.

Furthermore, an additional step includes, as at 710, within those transactions that are payments to the billers 1002 that are payment card issuers such as 2010, determining a proportional amount (e.g., a percentage or a fraction or decimal) attributable to each of a plurality of brands of payment card products. This step can be carried out, for example, by querying a relational database management system; for example, by running a query on Biller ID or the like, and then performing the calculations with an analytics module as discussed below.

A still further step 711 includes making the proportional amount available for computation; for example, via an application program interface (API), web service, or simply storing it in volatile or non-volatile memory. The proportional amount can be made available for computation by the same entity that performed the method steps, or a different entity.

In some embodiments, a further step includes, identifying, in the region of interest, an amount of spending at a particular merchant for one particular brand of the plurality of brands of payment card products. This step can be carried out, for example, running a query on database 2021. Another additional step 714 includes estimating a total amount of spending with all of the plurality of brands of payment card products, at the particular merchant, by scaling the amount of spending at the particular merchant for the one particular brand of payment card products, using the proportional amount. This step can be carried out, for example, at least in part, with an analytics module as discussed below.

Processing continues at 718.

Thus, one or more embodiments permit “plastic” tender scaling. In some instances, optional step 716 includes estimating the total amount of spending with all forms of payment, at the particular merchant, by adjusting the total amount of spending with all of the plurality of brands of payment card products using a factor indicative of payment card spending as a fraction of total spending (e.g., payment cards, cash, check) in the region of interest. Refer to the non-limiting example above, wherein total payment card receipts at ABC Dry Cleaners are $300/0.35=$857, and total receipts at ABC Dry Cleaners are $857/0.75=$1143. The factor indicative of payment card spending as a fraction of total spending can be determined, for example, by estimation from financial statements or the like.

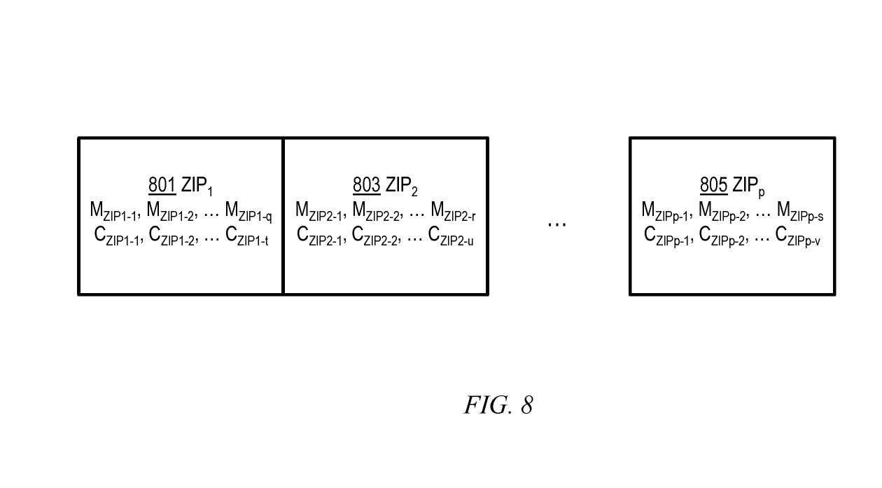

In some cases, in the step 706 of identifying the subset of records in the database that are associated with the subset of customers in the region of interest, the region of interest is a geographic region defined by a common postal code. For example, as shown in FIG. 8, a country or other entity may have many (say, “p”) different regions of interest 801, 803, 805, each with a postal code ZIP₁, ZIP₂, . . . ZIPₚ. Within each different region of interest, there may be many different merchants M; say, q merchants in region 801, r merchants in region 803, and s merchants in region 805; q, r, and s are integers which can be equal but in general will be different. Furthermore, within each different region of interest, there may be many different card holders; say, t card holders in region 801, u card holders in region 803, and v card holders in region 805; t, u, and v are integers which can be equal but in general will be different. For simplicity, the geographic regions in FIG. 8 are shown as rectangles, and only three are shown, it being understood that typical countries or other entities will be irregularly shaped and will have many more than three zip or other postal codes; furthermore, zip or other postal codes will typically be for regions which are irregularly shaped. So, in the non-limiting example, the region of interest might be the geographic region 803 defined by a common postal code ZIP₂; say, 11227; the customers therein are C_{ZIP2-1}, C_{ZIP2-2} . . . C_{ZIP2-u}; and the merchants therein are M_{ZIP2-1}, M_{ZIP2-2} . . . M_{ZIP2-r}. Of course, the regions could be further broken down by ZIP+4 codes or the like. The subset of records in the database 1099 that are associated with the subset of customers in the region of interest can be identified, for example, by querying the database 1095 for the zip code 11227 in the customer address.

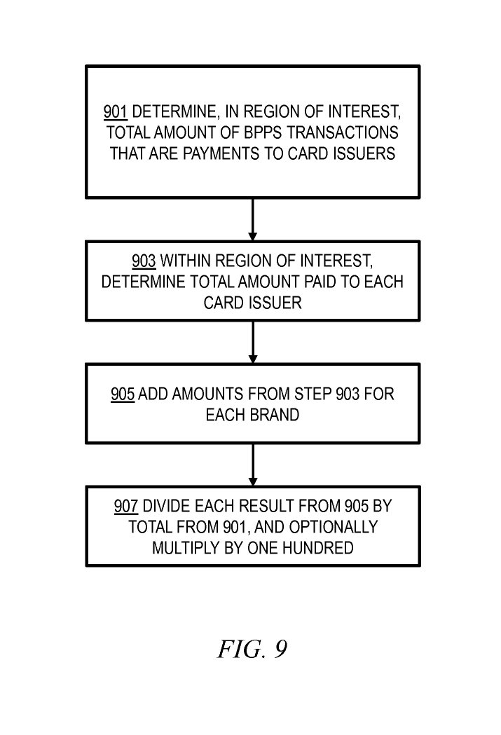

Referring to FIG. 9, which shows a flow chart of one specific way to carry out step 710, in some cases, the determining of the proportional amount includes, as at sub-step 901, determining a total amount of the transactions that are payments to the billers that are payment card issuers (i.e., within a given region of interest such as 803). A further sub-step includes, as at 903, determining, within the transactions that are payments to the billers that are payment card issuers, a total amount paid to each of the billers that are payment card issuers. A still further sub-step includes, as at 905, adding, for each of the plurality of brands of payment card products, the total amount paid to each of the billers that are payment card issuers for each given one of the plurality of brands of payment card products. An even further sub-step includes, as at 907, for each of the plurality of brands of payment card products, dividing the total amount paid to each of the billers that are payment card issuers for each brand of payment card products, by the total amount of the transactions that are payments to the billers that are payment card issuers. Optionally, multiply the result for each brand by one hundred to obtain a percentage. Refer to discussion of FIG. 6 for non-limiting illustrative examples.

In an alternative approach, replace steps 903 and 905 with a single step of determining, within the transactions that are payments to the billers that are payment card issuers, the total amount paid to each of the billers that are payment card issuers for each given one of the plurality of brands of payment card products; for example, by determining the brand directly from the account number in the memo section, consulting the biller directory based on the payee, and the like.

In some instances, the steps 704, 706, 708, 710, and 711 (and optionally steps 712, 714, and/or 716) are carried out by a single entity which operates both the electronic bill presentment system and a payment processing network for at least one of the plurality of brands of payment card products. One non-limiting example of such an entity is MasterCard International Incorporated of Purchase, New York, USA, which operates the BANKNET network (refer to FIGS. 1 and 2) for transaction of debit, credit, and stored value card accounts, and the RPPS® bill presentment and payment system.

Thus, one or more embodiments leverage on-line BPPS platforms to determine scaling factors in an automated fashion. It is worth noting that presentment functionality is not necessarily present in all embodiments; as long as data is present that allows determination of the payment market share for each brand of payment card product that is of interest. However, when presentment functionality is available, further refinement is advantageously possible—for example, when a cardholder pays the minimum amount, or some amount less than the full amount, this can be determined in embodiments where presentment functionality is available. The entire new amount charged can then be determined, as described with regard to the improved scaling example in FIG. 6.

Thus, in some cases, in step 704, the electronic bill payment system further has bill presentment capability, and step 710 is based on data from the bill presentment functionality when less than payment in full is made in at least some of the transactions that are payments to the billers that are payment card issuers. Refer to the above February 2014 example for Bank of America MasterCard and BAC American Express, taking into account amounts owed.

Some embodiments build a geographical database of scaling factors. For example, some embodiments repeat the steps in FIG. 7 for many, or even all, of the regions of interest in a particular area; for example, all of the postal codes in a given country, such as all of the ZIP (optionally ZIP+4) codes in the US. In some cases, access to the resulting database can be offered as a software-as-a-service (SaaS) solution to customers desiring to carry out tender-type scaling. In some cases, access can be provided via an application program interface (API) or web service that will allow application of the pertinent scaling factor for a given ZIP code or other region to any desired amount.

### System and Article of Manufacture Details

Embodiments of the invention can employ hardware and/or hardware and software aspects. Software includes but is not limited to firmware, resident software, microcode, etc. Software might be employed, for example, in connection with one or more of queries to databases 2021, 1099; a terminal 122, 124, 125, 126; a reader 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader 132.

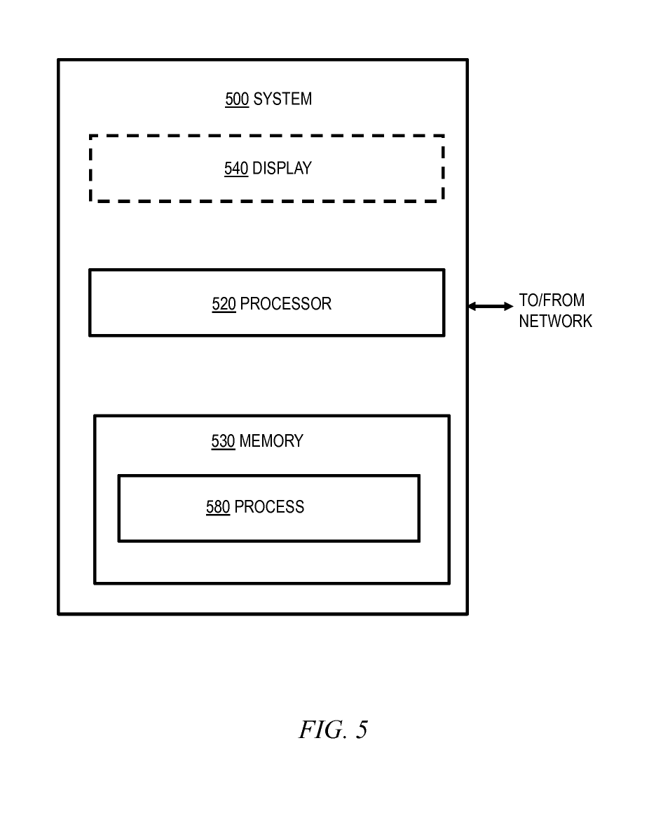

FIG. 5 is a block diagram of a system 500 that can implement part or all of one or more aspects or processes of the invention. As shown in FIG. 5, memory 530 configures the processor 520 (which could correspond, e.g., to processor portions 106, 116, 130; a processor of a terminal or a reader 132; processors of remote hosts in centers 140, 142, 144; processors of hosts and/or servers implementing various functionality such as that for querying databases 2021 and/or 1099; and the like); to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010, 1006; on a computer interacting with databases 2021, 1099; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 122, 124, 125, 126, 140, 142, 144, 2004, 2006, 2008, 2010, 1006; a computer interacting with databases 2021, 1099, and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components. A “host” includes a physical data processing system (for example, system 500 as shown in FIG. 5) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. Referring to FIG. 3, in one or more embodiments, the modules include a database module, an analytics module 1091, and an interactivity module 1089. The database module can include, for example, a relational database management system (RDBMS) 1093 which provides access to databases 1099, 2021 via queries and the like. The analytics module can include, for example, a spreadsheet that interfaces with the database(s); custom-written code (e.g., high level) that takes the results of the database queries as an input; an analytical package such as SAS Visual Analytics software available from SAS Institute, Inc., Cary, N.C., US; that takes the results of the database queries as an input; or an in-database analytics package such as the DB Lytix package available from Fuzzy Logix, LLC Charlotte, N.C., USA. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers or personal computers, located at one or more of the entities in the figures, as well as within the payment network 2008 and/or payment system 1006. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), and the like. The computers can be programmed to implement the logic and/or data flow depicted in the figures. In some instances, messaging and the like may be in accordance with the International Organization for Standardization (ISO) Specification 5583 Financial transaction card originated messages—Interchange message specifications and/or the ISO 20022 or UNIFI Standard for Financial Services Messaging, also incorporated herein by reference in its entirety for all purposes. In some instances, some messages may be in accordance with NACHA Automated Clearing House (ACH) rules and regulations.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining access to a database of transactions in an electronic bill payment system connecting a plurality of customers with a plurality of billers, at least some of said billers comprising payment card issuers;
identifying a subset of records in said database associated with a subset of said customers in a region of interest;
identifying, in said subset of records, transactions comprising payments to said billers comprising payment card issuers;
within said transactions comprising payments to said billers comprising payment card issuers, determining a proportional amount attributable to each of a plurality of brands of payment card products; and
making said proportional amount available for computation.

2. The method of claim 1, further comprising:
identifying, in said region of interest, an amount of spending at a particular merchant for one particular brand of said plurality of brands of payment card products; and
estimating a total amount of spending with all of said plurality of brands of payment card products, at said particular merchant, by scaling said amount of spending at said particular merchant for said one particular brand of said plurality of brands of payment card products, using said proportional amount.

3. The method of claim 2, further comprising estimating a total amount of spending with all forms of payment, at said particular merchant, by adjusting said total amount of spending with all of said plurality of brands of payment card products using a factor indicative of payment card spending as a fraction of total spending in said region of interest.

4. The method of claim 1, wherein, in said step of identifying said subset of records in said database associated with said subset of said customers in said region of interest, said region of interest comprises a geographic region defined by a common postal code.

5. The method of claim 1, wherein said determining of said proportional amount comprises:
determining a total amount of said transactions comprising payments to said billers comprising payment card issuers;
determining, within said transactions comprising payments to said billers comprising payment card issuers, a total amount paid to each of said billers comprising payment card issuers;
adding, for each of said plurality of brands of payment card products, said total amount paid to each of said billers comprising payment card issuers for each given one of said plurality of brands of payment card products; and
dividing for each of said plurality of brands of payment card products, said total amount paid to each of said billers comprising payment card issuers for each given one of said plurality of brands of payment card products, by said total amount of said transactions comprising payments to said billers comprising payment card issuers.

6. The method of claim 1, wherein said determining of said proportional amount comprises:
determining a total amount of said transactions comprising payments to said billers comprising payment card issuers;
determining, within said transactions comprising payments to said billers comprising payment card issuers, said total amount paid to each of said billers comprising payment card issuers for each given one of said plurality of brands of payment card products; and
dividing for each of said plurality of brands of payment card products, said total amount paid to each of said billers comprising payment card issuers for each given one of said plurality of brands of payment card products, by said total amount of said transactions comprising payments to said billers comprising payment card issuers.

7. The method of claim 1, wherein said steps of obtaining access to said database of transactions; identifying said subset of records; identifying, in said subset of records, said transactions comprising payments to said billers comprising payment card issuers; determining said proportional amount; and making said proportional amount available for computation, are carried out by a single entity which operates both:
said electronic bill payment system; and
a payment processing network for at least one of said plurality of brands of payment card products.

8. The method of claim 1, wherein, in said step of obtaining access to said database of transactions in said electronic bill payment system connecting said plurality of customers with said plurality of billers, said electronic bill payment system further has bill presentment capability, and wherein said determining of said proportional amount attributable to each of said plurality of brands of payment card products is based on data from said bill presentment functionality when less than payment in full is made in at least some of said transactions comprising payments to said billers comprising payment card issuers.

9. The method of claim 1, further comprising providing a system, wherein the system comprises distinct software modules, each of the distinct software modules being embodied on a non-transitory computer-readable storage medium, and wherein the distinct software modules comprise a database module, an analytics module, and an interactivity module;
wherein:
said obtaining of said access to said database, said identifying of said subset of records, and said identifying of said transactions are carried out by said database module executing on at least one hardware processor;
said determining of said proportional amount is carried out at least by said analytics module executing on said at least one hardware processor; and
said making of said proportional amount available for computation is carried out by said interactivity module executing on said at least one hardware processor.

10. An apparatus comprising:
a memory;
at least one processor operatively coupled to said memory; and
a persistent storage device operatively coupled to said memory and storing in a non-transitory manner instructions which when loaded into said memory cause said at least one processor to be operative to:
obtain access to a database of transactions in an electronic bill payment system connecting a plurality of customers with a plurality of billers, at least some of said billers comprising payment card issuers;
identify a subset of records in said database associated with a subset of said customers in a region of interest;
identify, in said subset of records, transactions comprising payments to said billers comprising payment card issuers;
within said transactions comprising payments to said billers comprising payment card issuers, determine a proportional amount attributable to each of a plurality of brands of payment card products; and
make said proportional amount available for computation.

11. The apparatus of claim 10, wherein said persistent storage device further stores in a non-transitory manner instructions which when loaded into said memory cause said at least one processor to be operative to:
identify, in said region of interest, an amount of spending at a particular merchant for one particular brand of said plurality of brands of payment card products; and
estimate a total amount of spending with all of said plurality of brands of payment card products, at said particular merchant, by scaling said amount of spending at said particular merchant for said one particular brand of said plurality of brands of payment card products, using said proportional amount.

12. The apparatus of claim 11, wherein said persistent storage device further stores in a non-transitory manner instructions which when loaded into said memory cause said at least one processor to be operative to estimate a total amount of spending with all forms of payment, at said particular merchant, by adjusting said total amount of spending with all of said plurality of brands of payment card products using a factor indicative of payment card spending as a fraction of total spending in said region of interest.

13. The apparatus of claim 10, wherein said region of interest comprises a geographic region defined by a common postal code.

14. The apparatus of claim 10, wherein said instructions which when loaded into said memory cause said at least one processor to be operative to determine said proportional amount comprise instructions which when loaded into said memory cause said at least one processor to be operative to:
determine a total amount of said transactions comprising payments to said billers comprising payment card issuers;
determine, within said transactions comprising payments to said billers comprising payment card issuers, a total amount paid to each of said billers comprising payment card issuers;
add, for each of said plurality of brands of payment card products, said total amount paid to each of said billers comprising payment card issuers for each given one of said plurality of brands of payment card products; and
divide, for each of said plurality of brands of payment card products, said total amount paid to each of said billers comprising payment card issuers for each given one of said plurality of brands of payment card products, by said total amount of said transactions comprising payments to said billers comprising payment card issuers.

15. The apparatus of claim 10, wherein said instructions which when loaded into said memory cause said at least one processor to be operative to determine said proportional amount comprise instructions which when loaded into said memory cause said at least one processor to be operative to:
determine a total amount of said transactions comprising payments to said billers comprising payment card issuers;
determine, within said transactions comprising payments to said billers comprising payment card issuers, said total amount paid to each of said billers comprising payment card issuers for each given one of said plurality of brands of payment card products; and
divide, for each of said plurality of brands of payment card products, said total amount paid to each of said billers comprising payment card issuers for each given one of said plurality of brands of payment card products, by said total amount of said transactions comprising payments to said billers comprising payment card issuers.

16. The apparatus of claim 10, wherein the electronic bill payment system further has bill presentment capability, and wherein said instructions which when loaded into said memory cause said at least one processor to be operative to determine said proportional amount based on data from said bill presentment functionality when less than payment in full is made in at least some of said transactions comprising payments to said billers comprising payment card issuers.

17. The system of claim 10, wherein said instructions on said persistent storage device comprise distinct software modules, and wherein said distinct software modules comprise a database module, an analytics module, and an interactivity module;
wherein:
said database module comprises said instructions which cause said at least one processor to obtain said access to said database, identify said subset of records, and identify said transactions;
said analytics module comprises said instructions which cause said at least one processor to determine said proportional amount; and
said interactivity module comprises said instructions which cause said at least one processor to make said proportional amount available for computation.

18. An apparatus comprising:
means for obtaining access to a database of transactions in an electronic bill payment system connecting a plurality of customers with a plurality of billers, at least some of said billers comprising payment card issuers;
means for identifying a subset of records in said database associated with a subset of said customers in a region of interest;
means for identifying, in said subset of records, transactions comprising payments to said billers comprising payment card issuers;
means for, within said transactions comprising payments to said billers comprising payment card issuers, determining a proportional amount attributable to each of a plurality of brands of payment card products; and
means for making said proportional amount available for computation.

19. An article of manufacture comprising a computer program product, said computer program product comprising:
a tangible computer-readable recordable storage medium, storing in a non-transitory manner computer readable program code, the computer readable program code comprising:
computer readable program code configured to obtain access to a database of transactions in an electronic bill payment system connecting a plurality of customers with a plurality of billers, at least some of said billers comprising payment card issuers;
computer readable program code configured to identify a subset of records in said database associated with a subset of said customers in a region of interest;
computer readable program code configured to identify, in said subset of records, transactions comprising payments to said billers comprising payment card issuers;
computer readable program code configured to, within said transactions comprising payments to said billers comprising payment card issuers, determine a proportional amount attributable to each of a plurality of brands of payment card products; and
computer readable program code configured to make said proportional amount available for computation.

20. The article of manufacture of claim 19, further comprising:
computer readable program code configured to identify, in said region of interest, an amount of spending at a particular merchant for one particular brand of said plurality of brands of payment card products; and
computer readable program code configured to estimate a total amount of spending with all of said plurality of brands of payment card products, at said particular merchant, by scaling said amount of spending at said particular merchant for said one particular brand of said plurality of brands of payment card products, using said proportional amount.
